(19) United States
(12) Patent Application Publication
(10) Pub. No.: US 2011/0087387 A1
(43) Pub. Date: Apr. 14, 2011

(54) Platform Health Monitoring System

(75) Inventors: Robab Safa-Bakhsh, Ambler, PA (US); Patrick Neal Harris, Bonney Lake, WA (US)

(73) Assignee: The Boeing Company, Chicago, IL (US)

(21) Appl. No.: 12/577,549

(22) Filed: Oct. 12, 2009

(51) Int. Cl. G06F 7/00; G01C 21/00; G06F 15/00

(52) U.S. Cl. 701/16; 701/200; 701/21; 701/19; 701/99; 701/3; 702/184

(57) ABSTRACT

A method and apparatus are present for monitoring a platform. Information from monitoring the platform is received from a sensor network and a number of systems associated with the platform. A plurality of observations is formed from the information. A profile is created from the plurality of observations in which the profile is used to monitor the platform.

### BACKGROUND INFORMATION

1. Field

The present disclosure relates generally to platforms and, in particular, to a method and apparatus for monitoring platforms. Still more particularly, the present disclosure relates to a method and apparatus for monitoring the health and function of platform systems and subsystems.

2. Background

A platform may take the form of, for example, without limitation, a mobile platform, a stationary platform, a land-based structure, an aquatic-based structure, a space-based structure, an aircraft, a submarine, a bus, a personnel carrier, a tank, a train, an automobile, a spacecraft, a space station, a satellite, a surface ship, and/or some other suitable platform. The reliability of a platform is important to the operation and use of the platform.

For example, with aircraft, it is desirable to know when different components of the aircraft may need maintenance. The maintenance may be performed using maintenance schedules. These maintenance schedules typically are generated using histories for the different components. With the scheduled maintenance, unscheduled interruptions in the use of the aircraft may be avoided. Even with the scheduled maintenance, components may require replacement or maintenance at times other than those indicated by schedules. As a result, an aircraft may be out of service at unplanned times. This situation may require having additional aircraft or delays in transporting passengers or cargo.

Additionally, health monitoring systems are used to monitor various systems of a platform. Current health monitoring systems monitor components for indications that the component is not operating at a desired level of performance. The monitoring of a platform is performed by gathering information from these different components or sensors associated with the components. Currently available health monitoring systems receive and process large amounts of data from sensors for use in assessing the health of different systems and components in a platform.

Currently available health monitoring systems use specific types of data or data from specific sensors or sources to assess the health of a platform. For example, the health of a particular system may be derived from data collected from a particular set of sensors. Other available data related to the health of the platform is not used in identifying the health of that system.

Currently available systems, however, may not provide an identification of the health of a vehicle with a desired amount of accuracy. When the accuracy does not meet desired levels, increased maintenance may occur. This increased maintenance may be due to missed or late identification of maintenance problems. Further, false identification of maintenance problems also may lead to increased maintenance. For example, if maintenance needed for a transmission system of a vehicle is not identified with the desired amount of accuracy, maintenance may not be performed as soon as needed.

As a result, additional parts, expense, and time may be needed to obtain the desired performance from the transmission system. Timely maintenance of the transmission system, for example, may require fewer parts or no parts and merely a replacement of lubrication fluids.

Therefore, it would be advantageous to have a method and apparatus that addresses one or more of the issues discussed above, as well as possibly other issues.

### SUMMARY

In one advantageous embodiment, an apparatus comprises a sensor network associated with a platform, a number of systems associated with the platform, and a computer system connected to the sensor network and the number of systems. The sensor network is configured to monitor health of the platform. The number of systems and the sensor network are configured to provide information for the platform. The computer system is configured to receive the information, to process the information to form a plurality of observations from the information, and to create a current profile from the plurality of observations and the information in which the current profile is used to identify a health state for the platform.

In another advantageous embodiment, a system for monitoring health of a platform comprises a sensor network associated with the platform, a number of systems associated with the platform, and a computer system associated with the platform. The number of systems and the sensor network are configured to provide information for the platform. The computer system is in communication with the sensor network and the number of systems associated with the platform. The computer system is configured to receive the information from the sensor network and the number of systems associated with the platform. The computer system is configured to process the information to form a plurality of observations from the information, group the plurality of observations into a number of groups based on similarities between observations in the plurality of observations to form a current profile, compare the current profile to a number of known profiles to form a comparison, and identify a health state of the platform using the comparison.

In yet another advantageous embodiment, a method is present for monitoring a platform. Information from monitoring the platform is received from a sensor network and a number of systems associated with the platform. A plurality of observations is formed from the information. A profile is created from the plurality of observations in which the profile is used to monitor the platform.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is an illustration of a platform manufacturing and service method in accordance with an advantageous embodiment;

FIG. 2 is an illustration of an aircraft in which an advantageous embodiment may be implemented;

FIG. 3 is an illustration of a health monitoring environment in accordance with an advantageous embodiment;

FIG. 4 is an illustration of a data processing system in accordance with an advantageous embodiment;

FIG. 5 is an illustration of a flow of information in a computer system for a health monitoring system in accordance with an advantageous embodiment;

FIG. 6 is an illustration of a plurality of observations in accordance with an advantageous embodiment;

FIG. 7 is an illustration of a flowchart of a process for monitoring a platform in accordance with an advantageous embodiment;

FIG. 8 is an illustration of a flowchart for creating a profile in accordance with an illustrative embodiment;

FIG. 9 is an illustration of a flowchart for creating scores for observations in accordance with an advantageous embodiment; and

FIG. 10 is an illustration of a flowchart of a process for creating known profiles in accordance with an advantageous embodiment.

### DETAILED DESCRIPTION

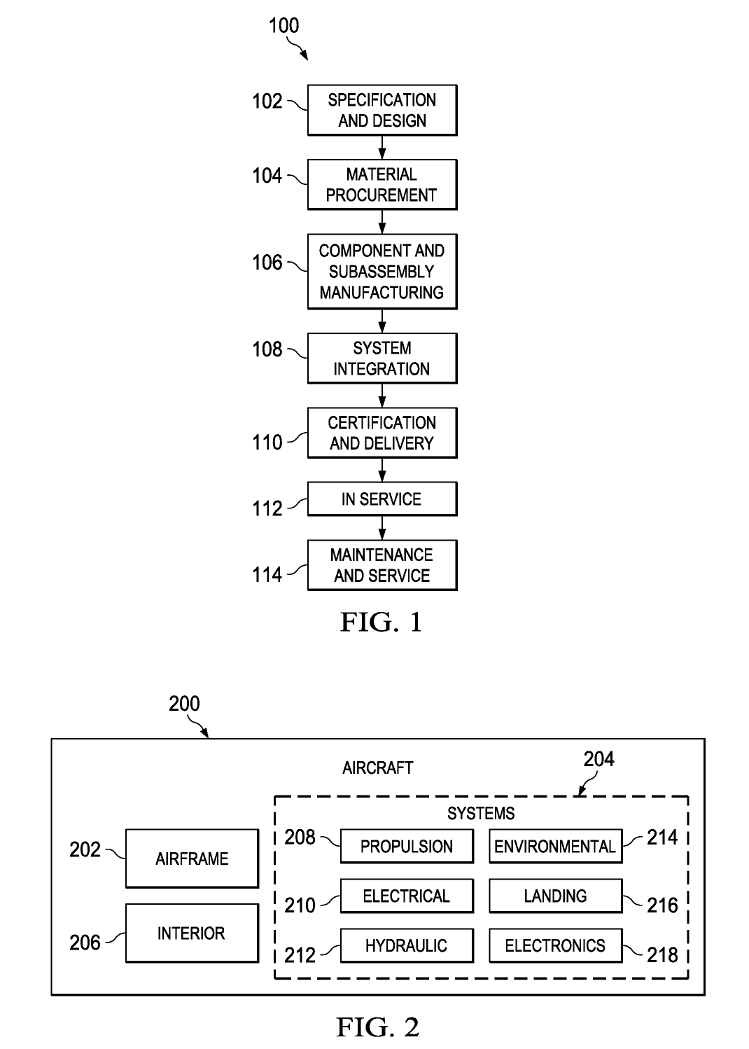

Referring more particularly to the drawings, embodiments of the disclosure may be described in the context of aircraft manufacturing and service method 100 as shown in FIG. 1 and aircraft 200 as shown in FIG. 2. Turning first to FIG. 1, an illustration of an aircraft manufacturing and service method is depicted in accordance with an advantageous embodiment. During pre-production, aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service 112 by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of venders, subcontractors, and suppliers; and an operator may be an airline, leasing company, military entity, service organization, and so on.

With reference now to FIG. 2, an illustration of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, environmental system 214, landing system 216, and electronics system 218. Any number of other systems may be included. Although an aerospace example is shown, different advantageous embodiments may be applied to other industries, such as the automotive industry.

Apparatus and methods embodied herein may be employed during at least one of the stages of aircraft manufacturing and service method 100 in FIG. 1. As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C or item B and item C.

In one illustrative example, components or subassemblies produced in component and subassembly manufacturing 106 in FIG. 1 may be fabricated or manufactured in a manner similar to components or subassemblies produced while aircraft 200 is in service 112 in FIG. 1. As yet another example, a number of apparatus embodiments, method embodiments, or a combination thereof may be utilized during production stages, such as component and subassembly manufacturing 106 and system integration 108 in FIG. 1.

A number, when referring to items, means one or more items. For example, a number of apparatus embodiments is one or more apparatus embodiments. A number of apparatus embodiments, method embodiments, or a combination thereof may be utilized while aircraft 200 is in service 112 and/or during maintenance and service 114 in FIG. 1. The use of a number of the different advantageous embodiments may substantially expedite the assembly of and/or reduce the cost of aircraft 200.

In these illustrative examples, a health monitoring system may be implemented in aircraft 200 during system integration 108 or maintenance and service 114. A health monitoring system, in accordance with an advantageous embodiment, may be used while in service 112 and/or during maintenance and service 114.

The different advantageous embodiments recognize and take into account a number of considerations. For example, the different advantageous embodiments recognize and take into account that in currently used health monitoring systems, the sensor data used to identify the condition of a component is often assigned by the designers of the health monitoring system.

The different advantageous embodiments recognize and take into account that this type of use of sensor data may not take into account other data that may affect a particular component. For example, changes or vibrations in a first system connected to a second system also may affect that second system. The different advantageous embodiments recognize and take into account that currently available health monitoring systems do not take into account all of the different systems or structures in the vehicle that may affect the system being monitored.

The different advantageous embodiments recognize and take into account that various types of analysis may be used to take into account additional data. For example, statistical analysis, data monitoring, signal processing, rule-based systems, fuzzy logic, genetic algorithms, Monte Carlo simulations, and/or other types of processes may be used. These different potential solutions, however, do not provide the desired results. With data monitoring, these types of processes are time consuming and costly in terms of processor resources.

These different processes also may not provide the desired level of accuracy with respect to identifying the state of different systems within a platform. For example, with statistical analysis, assumptions are based on large numbers of samples that are often not available. Further, statistical analysis reduces the amount of information collected to a smaller set of parameters. With complex systems, the assumptions made for this type of analysis and the processing techniques used may not model the system with the amount of desired accuracy.

As another example, with signal processing, data is relied on from a number of sensors for a particular component. These values are compared with a threshold to make identifications. This type of technique does not take into account other types of conditions that may occur in the vehicle. With rule-based systems, the different interactions between components in a vehicle may be difficult to identify and take into account.

Genetic algorithms may require more time than desired to obtain a proper configuration to identify the health of a vehicle. Monte Carlo simulations involve assumptions from random generators and statistics that may not be indicative of real world conditions.

The different advantageous embodiments recognize and take into account that a solution that takes into account sufficient data to more accurately identify the state of the vehicle is desirable. Thus, the different advantageous embodiments provide a method and apparatus for managing the health of a platform. In one advantageous embodiment, an apparatus comprises a computer system and a sensor network. The sensor network is associated with a platform. The computer system is connected to the sensor network and is configured to receive information from the sensor network. The computer system is configured to form observations from the information for a current profile. The computer system compares the current profile with a number of known profiles to identify a health state of the platform.

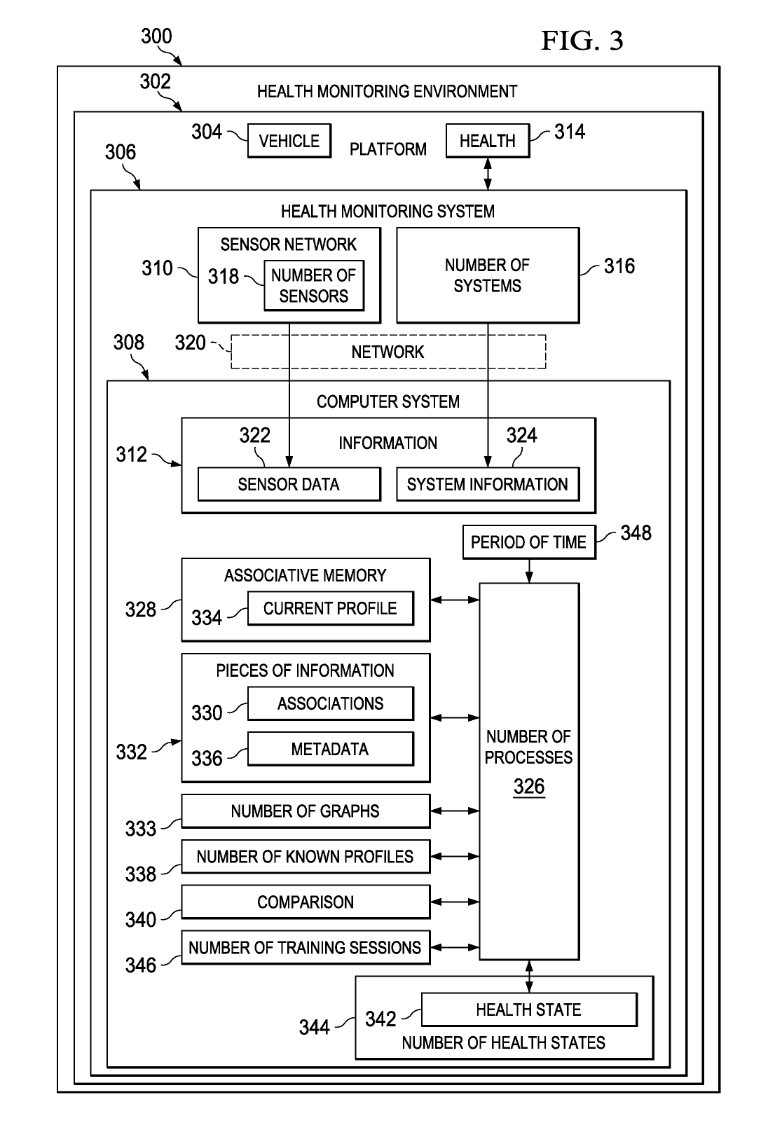

With reference now to FIG. 3, an illustration of a health monitoring environment is depicted in accordance with an advantageous embodiment. Health monitoring environment 300 may be implemented using platform 302. As illustrated, platform 302 takes the form of vehicle 304. Vehicle 304 may be implemented using aircraft 200 in FIG. 2.

As illustrated, health monitoring system 306 is associated with platform 302. A first component may considered to be associated with a second component by being secured to the second component, bonded to the second component, fastened to the second component, and/or connected to the second component in some other suitable manner. The first component also may be connected to the second component through using a third component. The first component also may be considered to be associated with the second component by being formed as part of and/or as an extension of the second component.

In these examples, health monitoring system 306 is comprised of computer system 308 and sensor network 310. Computer system 308 may include one or more computers that may be in communication with each other. Computer system 308 is configured to perform a number of operations in these illustrative examples. Computer system 308 receives at least a portion of information 312 from sensor network 310 to monitor health 314 of platform 302. Information 312 also may be received from number of systems 316 associated with platform 302.

In these illustrative examples, sensor network 310 comprises number of sensors 318 connected to network 320. Network 320, in turn, is connected to computer system 308 in these examples. Number of sensors 318 generates sensor data 322 in information 312. A sensor within number of sensors 318 is a device that measures a physical quantity and converts that measurement into a signal. This signal may be an analog signal or a digital signal, depending on the particular implementation. This signal forms a part of sensor data 322.

Number of sensors 318 may comprise a number of different types of sensors. For example, without limitation, number of sensors 318 may comprise at least one of a microphone, an accelerometer, a carbon dioxide sensor, a catalytic bead sensor, an oxygen sensor, a current sensor, a volt meter, an airflow sensor, a mask flow sensor, a hygrometer, a particle detector, an altimeter, a gyroscope, a yaw rate sensor, and/or some other suitable type of device.

In some illustrative examples, “at least one of” may be, for example, without limitation, two of item A, one of item B, and ten of item C; four of item B and seven of item C; and/or other suitable combinations.

Number of systems 316 may include, for example, without limitation, computers, avionics, a propulsion system, an environmental system, a hydraulic system, a maintenance system, and/or other suitable types of systems. Number of systems 316 generates system information 324, which may be used by health monitoring system 306. In these illustrative examples, system information 324 may include data, commands, logs, messages, and/or other suitable types of information that may be generated by number of sensors 318 and number of systems 316.

In this illustrative example, computer system 308 runs number of processes 326 to process information 312 for placement into associative memory 328. Computer system 308 analyzes associative memory 328 to form current profile 334. For example, number of processes 326 may form associations 330 between pieces of information 332 to form number of graphs 333 and/or current profile 334. In these illustrative examples, current profile 334 is for health 314 of platform 302. Current profile 334 may change as information 312 received by computer system 308 changes.

In this depicted example, current profile 334 is in associative memory 328. Associative memory 328 may take the form of a data construct, a data structure, and/or some other type of memory in this example. Further, associative memory 328 may not be physical memory in this example.

In processing information 312, number of processes 326 may associate or add metadata 336 to pieces of information 332. Metadata 336 may be used to create associations 330 between pieces of information 332. In these illustrative examples, metadata 336 may be comprised of at least one of timestamps for pieces of information 332 and identifiers of sources of pieces of information 332.

Current profile 334 may then be compared to number of known profiles 338 to form comparison 340. Comparison 340 is used to identify health state 342 for platform 302. Health state 342 identifies health 314 for platform 302. Health state 342 may be selected from number of health states 344 for number of known profiles 338. In these illustrative examples, number of health states 344 may include, for example, without limitation, new, operational, healthy, degraded, needs repair, repaired, and/or other suitable states.

In these illustrative examples, number of known profiles 338 may be created through number of training sessions 346 using platform 302. For example, in one training session in number of training sessions 346, all of information 312 received by health monitoring system 306 over period of time 348 may be identified as being for a particular health state within number of health states 344. For example, health state 342 may be “new” for period of time 348. Other profiles for number of known profiles 338 may be generated for other periods of time during number of training sessions 346.

The amount of information 312 collected may vary, depending on the particular implementation. For example, information 312 may be collected in a continuous manner, a uniform manner, a discontinuous manner, or a non-uniform manner. The information may be collected for a number of minutes, hours, days, or some other suitable period of time. Number of training sessions 346 may be performed for different known states of platform 302. Number of training sessions 346 may be performed specifically for platform 302 such that number of known profiles 338 accurately reflects different health states for platform 302.

In this manner, health monitoring system 306 may increase the availability of platform 302 as compared to currently used health monitoring systems. Comparison 340 of current profile 334 to number of known profiles 338 may be performed each time a piece of information is received by health monitoring system 306.

As yet another example, although platform 302 takes the form of vehicle 304 in these examples, platform 302 may take other forms. For example, platform 302 may be only a portion of vehicle 304. For example, platform 302 may be a propulsion system, a shaft, or some other part of vehicle 304.

The illustration of health monitoring environment 300 in FIG. 3 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some advantageous embodiments, health monitoring system 306 may only receive information 312 from sensor network 310 and may not receive information 312 from number of systems 316. In yet other advantageous embodiments, multiple health monitoring systems may be present to monitor different portions of platform 302.

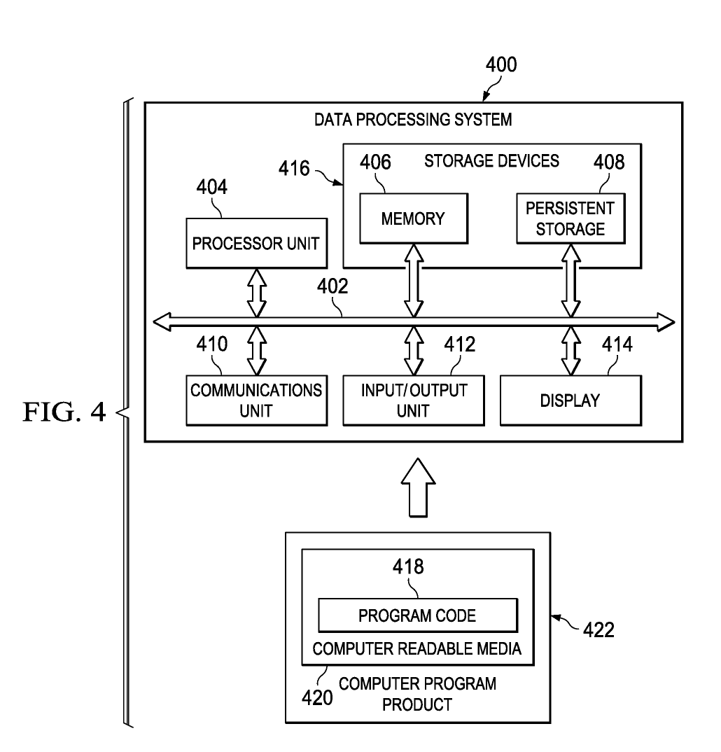

Turning now to FIG. 4, an illustration of a data processing system is depicted in accordance with an advantageous embodiment. In this illustrative example, data processing system 400 includes communications fabric 402, which provides communications between processor unit 404, memory 406, persistent storage 408, communications unit 410, input/output (I/O) unit 412, and display 414.

Processor unit 404 serves to execute instructions for software that may be loaded into memory 406. Processor unit 404 may be a set of one or more processors or may be a multi-processor core, depending on the particular implementation. Further, processor unit 404 may be implemented using one or more heterogeneous processor systems in which a main processor is present with secondary processors on a single chip. As another illustrative example, processor unit 404 may be a symmetric multi-processor system containing multiple processors of the same type.

Memory 406 and persistent storage 408 are examples of storage devices 416. A storage device is any piece of hardware that is capable of storing information such as, for example, without limitation, data, program code in functional form, and/or other suitable information either on a temporary basis and/or a permanent basis. Memory 406, in these examples, may be, for example, a random access memory or any other suitable volatile or non-volatile storage device.

Persistent storage 408 may take various forms, depending on the particular implementation. For example, persistent storage 408 may contain one or more components or devices. For example, persistent storage 408 may be a hard drive, a flash memory, a rewritable optical disk, a rewritable magnetic tape, or some combination of the above. The media used by persistent storage 408 also may be removable. For example, a removable hard drive may be used for persistent storage 408.

Communications unit 410, in these examples, provides for communications with other data processing systems or devices. In these examples, communications unit 410 is a network interface card. Communications unit 410 may provide communications through the use of either or both physical and wireless communications links.

Input/output unit 412 allows for input and output of data with other devices that may be connected to data processing system 400. For example, input/output unit 412 may provide a connection for user input through a keyboard, a mouse, and/or some other suitable input device. Further, input/output unit 412 may send output to a printer. Display 414 provides a mechanism to display information to a user.

Instructions for the operating system, applications, and/or programs may be located in storage devices 416, which are in communication with processor unit 404 through communications fabric 402. In these illustrative examples, the instructions are in a functional form on persistent storage 408. These instructions may be loaded into memory 406 for execution by processor unit 404. The processes of the different embodiments may be performed by processor unit 404 using computer-implemented instructions, which may be located in a memory, such as memory 406.

These instructions are referred to as program code, computer usable program code, or computer readable program code that may be read and executed by a processor in processor unit 404. The program code in the different embodiments may be embodied on different physical or tangible computer readable media, such as memory 406 or persistent storage 408.

Program code 418 is located in a functional form on computer readable media 420 that is selectively removable and may be loaded onto or transferred to data processing system 400 for execution by processor unit 404. Program code 418 and computer readable media 420 form computer program product 422 in these examples. In one example, computer readable media 420 may be in a tangible form such as, for example, an optical or magnetic disk that is inserted or placed into a drive or other device that is part of persistent storage 408 for transfer onto a storage device, such as a hard drive that is part of persistent storage 408. In a tangible form, computer readable media 420 also may take the form of a persistent storage, such as a hard drive, a thumb drive, or a flash memory that is connected to data processing system 400. The tangible form of computer readable media 420 is also referred to as computer recordable storage media. In some instances, computer readable media 420 may not be removable.

Alternatively, program code 418 may be transferred to data processing system 400 from computer readable media 420 through a communications link to communications unit 410 and/or through a connection to input/output unit 412. The communications link and/or the connection may be physical or wireless in the illustrative examples. The computer readable media also may take the form of non-tangible media, such as communications links or wireless transmissions containing the program code.

In some illustrative embodiments, program code 418 may be downloaded over a network to persistent storage 408 from another device or data processing system for use within data processing system 400. For instance, program code stored in a computer readable storage medium in a server data processing system may be downloaded over a network from the server to data processing system 400. The data processing system providing program code 418 may be a server computer, a client computer, or some other device capable of storing and transmitting program code 418.

The different components illustrated for data processing system 400 are not meant to provide architectural limitations to the manner in which different embodiments may be implemented. The different illustrative embodiments may be implemented in a data processing system including components in addition to or in place of those illustrated for data processing system 400. Other components shown in FIG. 4 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 400 is any hardware apparatus that may store data. Memory 406, persistent storage 408, and computer readable media 420 are examples of storage devices in a tangible form.

In another example, a bus system may be used to implement communications fabric 402 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 406 or a cache such as found in an interface and memory controller hub that may be present in communications fabric 402.

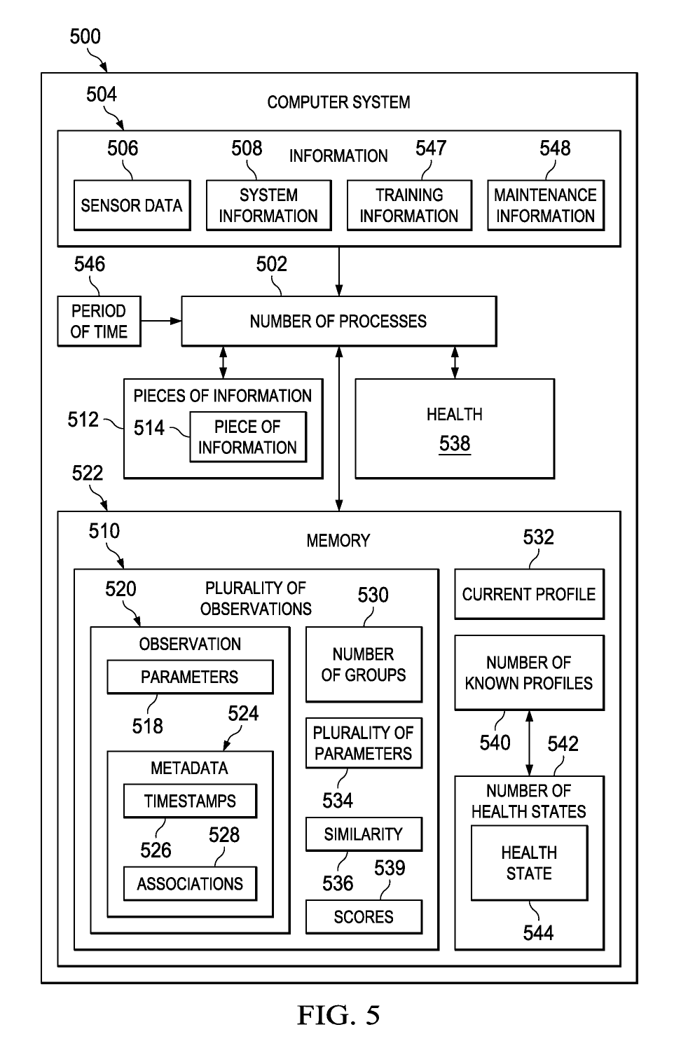

Turning now to FIG. 5, an illustration of a flow of information in a computer system for a health monitoring system is depicted in accordance with an advantageous embodiment. In this illustrative example, computer system 500 may include one or more computers that may be implemented using data processing system 400 in FIG. 4.

In this illustrative example, number of processes 502 runs on computer system 500. Number of processes 502 receives information 504 in the form of at least one of sensor data 506 and system information 508. Number of processes 502 forms plurality of observations 510 using at least one of sensor data 506 and system information 508.

For example, number of processes 502 identifies pieces of information 512 within information 504. Piece of information 514 within pieces of information 512 may be identified based on when piece of information 514 was received. All information within piece of information 514 may be placed into parameters 518 for observation 520. Parameters 518 are variables filled with information from piece of information 514. Each parameter in parameters 518 may be a variable in which a value or text may be placed.

When parameters 518 are filled using piece of information 514, observation 520 in plurality of observations 510 is formed. Observation 520 is stored in plurality of observations 510 in memory 522.

Further, metadata 524 also may be included in observation 520. Metadata 524 may be, for example, without limitation, timestamps 526. In these illustrative examples, metadata 524 also may include associations 528. Associations 528 may be used to create associations between plurality of observations 510. Number of groups 530 is formed by plurality of observations 510 that are associated to each other based on similarities between plurality of observations 510. In these illustrative examples, when plurality of observations 510 are grouped into number of groups 530, current profile 532 is formed.

In these illustrative examples, plurality of observations 510 may be grouped into number of groups 530 based on a similarity of observations within plurality of observations 510 with each other. For example, parameters 518 in observation 520 may be compared with plurality of parameters 534 for other observations in plurality of observations 510. Based on this comparison, similarity 536 may be identified between observation 520 and other observations within plurality of observations 510. Scores 539 may be assigned to the other observations in plurality of observations 510.

Thereafter, scores 539 may be used to determine whether an association should be formed between observation 520 and each of the other observations in plurality of observations 510. This process may be performed for all of the other observations in plurality of observations 510.

Current profile 532 may be used to identify health 538 of a platform. For example, current profile 532 may be compared to number of known profiles 540. In these illustrative examples, each profile within number of known profiles 540 corresponds to number of health states 542 for the platform. A match with a profile in number of known profiles 540 or a closest match to a profile within number of known profiles 540 may be used to identify health state 544 within number of health states 542 for the platform. Health state 544 indicates health 538 of the platform.

Additionally, number of processes 502 may be run to create number of known profiles 540. For example, information 504 received during period of time 546 may be training information 547 for the platform during a particular health state. Number of processes 502 may be run for other periods of time to identify other known profiles.

Further, number of processes 502 may be run using a history of information 504 instead of during the collection of information 504 to create number of known profiles 540. Training information 547 may be identified using timestamps 526. Training information 547 is comprised of information previously collected. In some examples, timestamps 526 may be included in training information 547.

In addition, maintenance information 548 also may be used in creating number of known profiles 540. In some advantageous embodiments, maintenance information 548 may be a portion of training information 547. Maintenance information 548 may include information about a number of maintenance events. For example, maintenance information 548 may indicate when new components are added, when repairs are made, when replacements are made, and/or other suitable information. This information may be used to identify an improperly installed part or an incorrect part.

Further, in some advantageous embodiments, computer system 500 selects a portion of plurality of observations 510 based on maintenance information 548. Computer system 500 selects the portion using the number of maintenance events and/or metadata. The metadata may comprise at least one of a timestamp for a piece of information and an identifier of a source of the piece of information. Current profile 532 may be created from the portion of plurality of observations 510 in these examples.

As a specific example, plurality of observations 510 may be formed based on information 504 for a landing system of an aircraft. Maintenance information 548 may indicate that a part of the landing system was replaced during the formation of plurality of observations 510. Maintenance information 548 and metadata 524 may be used to select the portion of plurality of observations 510 that was formed after the replacement of the part. The selected portion may then be used to create current profile 532.

The illustration of computer system 500 in FIG. 5 is not meant to imply physical or architectural limitations to the manner in which different advantageous embodiments may be implemented. For example, in some advantageous embodiments, number of known profiles 540 may be located in a remote location from computer system 500. As another example, one process in number of processes 502 may collect information 504 to form current profile 532. Another process may form associations 528 between plurality of observations 510 to form current profile 532.

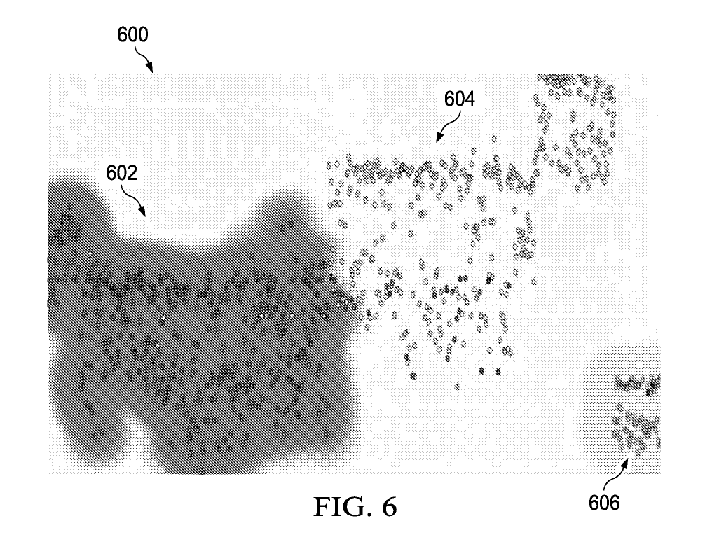

With reference now to FIG. 6, an illustration of a plurality of observations is depicted in accordance with an advantageous embodiment. Plurality of observations 600 is an example of one implementation of plurality of observations 510 in FIG. 5. Plurality of observations 600 comprise parameters for monitoring the health of a platform.

In this illustrative example, plurality of observations 600 may comprise observations that are formed based on information, such as information 504 in FIG. 5. As depicted, plurality of observations 600 are grouped into group 602, group 604, and group 606. Each of these groups comprises observations within plurality of observations 600 having a similarity.

Further, each of groups 602, 604, and 606 correspond to a health state. In this illustrative example, observations in group 602 correspond to a “degraded” health state. Observations in group 604 correspond to a “needs repair” health state. In some examples, the “needs repair” health state also may be referred to as a “faulty” health state. Observations in group 606 correspond to a “repaired” health state. In some examples, a “repaired” health state also may be referred to as a “healthy” state.

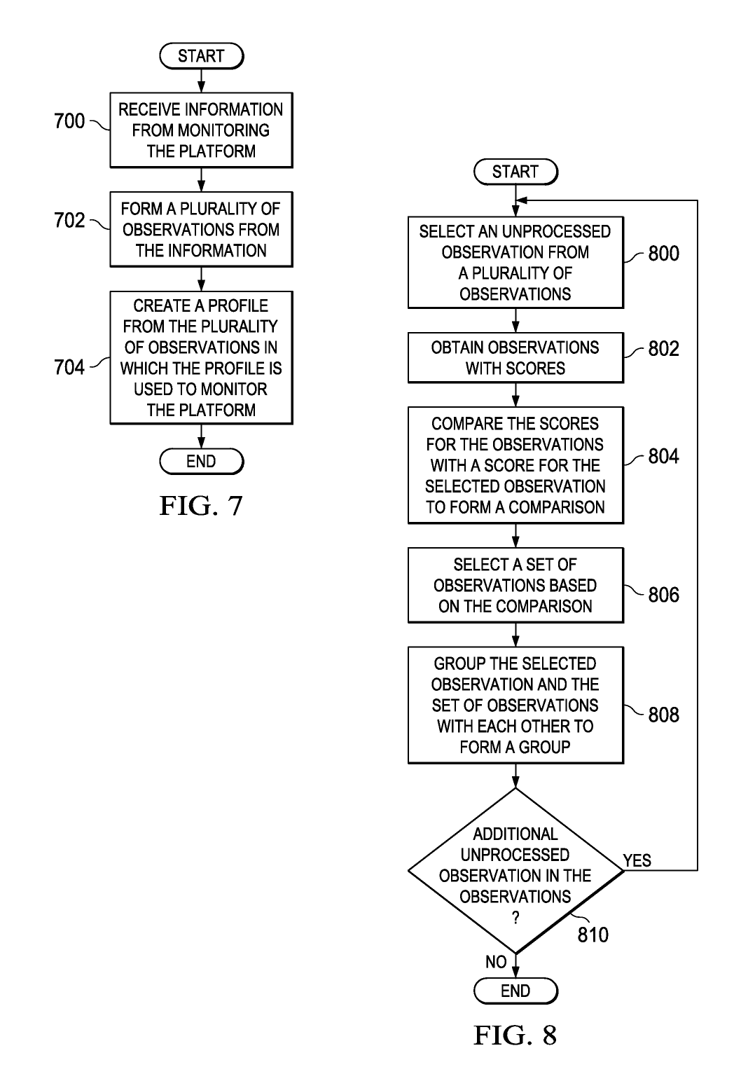

With reference now to FIG. 7, an illustration of a flowchart of a process for monitoring a platform is depicted in accordance with an advantageous embodiment. The process in FIG. 7 may be implemented in health monitoring system 306 in health monitoring environment 300 in FIG. 3.

The process begins by receiving information from monitoring the platform (operation 700). The monitoring of the platform may be performed by receiving information from a sensor network associated with the platform. This monitoring also may occur by receiving information from a number of systems on the platform.

The process then forms a plurality of observations from the information (operation 702). These observations may be formed by identifying pieces of information in the information received. An observation is created from each piece of information to form the plurality of observations. In these illustrative examples, a piece of information may be identified as a piece of information at a particular time or within a particular period of time. The different values or text in the piece of information may be placed into parameters for an observation.

The process then creates a profile from the plurality of observations in which the profile is used to monitor the platform (operation 704), with the process terminating thereafter. The creation of the profile may be performed in a number of different ways. For example, the formation of the profile may occur by placing the plurality of observations in a memory. In other advantageous embodiments, the profile may be created when groupings of the plurality of observations are made.

The profile created in FIG. 7 may be a current profile when the information is collected during operation of the platform and analyzed to identify a health state for the profile. This health state may be used to indicate the health of the platform. In other advantageous embodiments, the profile may be a known profile that is created for use in monitoring a platform. When the profile is a known profile, the information also may include maintenance information.

With reference now to FIG. 8, an illustration of a flowchart for creating a profile is depicted in accordance with an illustrative embodiment. The process illustrated in FIG. 8 may be implemented in number of processes 326 in FIG. 3 or number of processes 502 in FIG. 5.

The process begins by selecting an unprocessed observation from a plurality of observations (operation 800). The process then obtains observations with scores (operation 802). In operation 802, these observations are observations other than the selected observation. In this illustrative example, these scores identify a similarity of the observations to the selected observation.

The process then compares the scores for the observations with a score for the selected observation to form a comparison (operation 804). A set of observations is selected based on the comparison (operation 806). In these illustrative examples, the set of observations may contain no observations, one observation, or any other number of observations from the observations from which the comparison was made. Next, the selected observation and the set of observations are grouped with each other to form a group (operation 808).

A determination is made as to whether an additional unprocessed observation is present in the observations (operation 810). If an additional unprocessed observation is present, the process returns to operation 800 as described above. Otherwise, the process terminates once processing of the observations is completed and the profile has been formed.

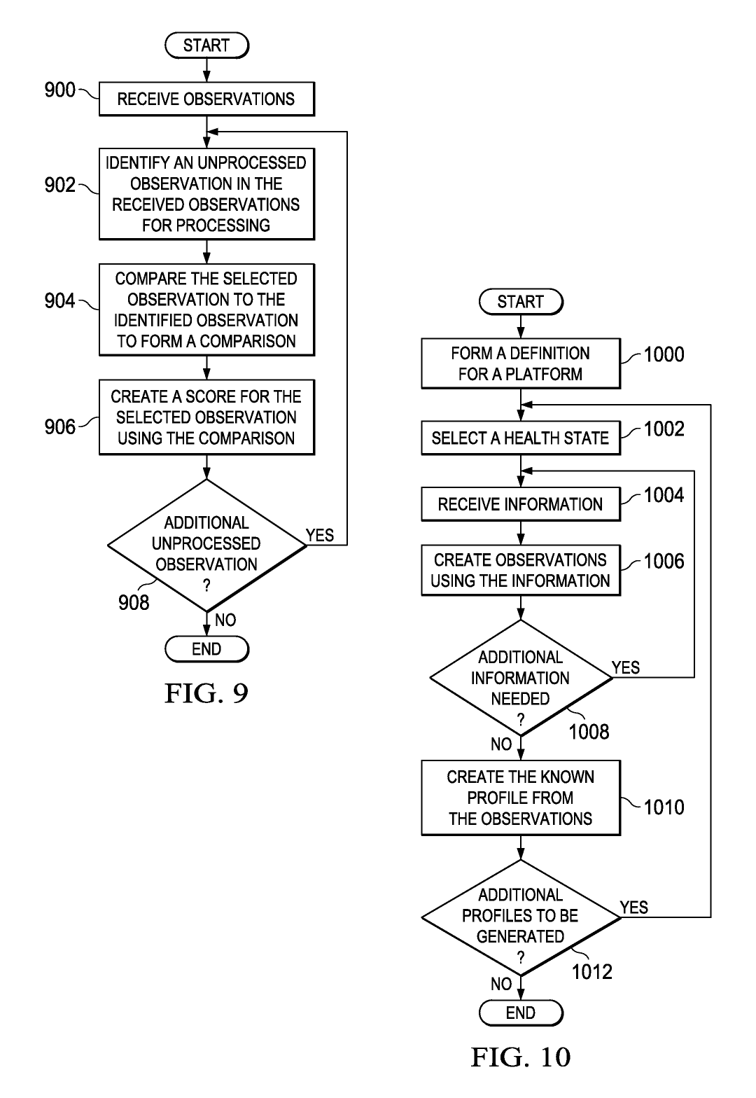

With reference now to FIG. 9, an illustration of a flowchart for creating scores for observations is depicted in accordance with an advantageous embodiment. The process illustrated in FIG. 9 is an example of one implementation of operation 802 in FIG. 8.

The process begins by receiving observations (operation 900). These observations are observations for which scores are desired with respect to a selected observation from which a similarity score is desired. The selected observation may be an unprocessed observation selected in operation 800 in FIG. 8. The process identifies an unprocessed observation in the received observations for processing (operation 902). The selected observation is compared to the identified observation to form a comparison (operation 904).

A score is created for the selected observation using the comparison (operation 906). A determination is made as to whether an additional unprocessed observation is present in the received observations (operation 908). If an additional unprocessed observation is present, the process returns to operation 902. Otherwise, the process terminates.

Turning now to FIG. 10, an illustration of a flowchart of a process for creating known profiles is depicted in accordance with an advantageous embodiment. The process illustrated in FIG. 10 may be implemented in health monitoring environment 300 in FIG. 3. Further, the process may be implemented within number of processes 326 in FIG. 3.

The process begins by forming a definition for a platform (operation 1000). This platform may be an entire vehicle, a subsystem, a component, or some other suitable portion of a platform. The definition for the platform includes parameters for observations.

The process then selects a health state (operation 1002). This health state is for the known profile that is to be generated. The process then receives information (operation 1004). In these examples, operation 1004 may be performed during operation of the platform. In some advantageous embodiments, the information may be a history of information previously collected for the platform. The process then creates observations using the information (operation 1006).

A determination is then made as to whether additional information is needed (operation 1008). If additional information is needed, the process returns to operation 1004. Otherwise, the process creates the known profile from the observations (operation 1010). A determination is then made as to whether additional profiles are to be generated (operation 1012). If additional profiles are to be generated, the process returns to operation 1002. Otherwise, the process terminates.

The flowcharts and block diagrams in the different depicted embodiments illustrate the architecture, functionality, and operation of some possible implementations of apparatus, methods, and computer program products. In this regard, each block in the flowcharts or block diagrams may represent a module, segment, or portion of computer-usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

For example, in some advantageous embodiments, the selection of a health state in operation 1002 may be performed after the creation of the known profile in operation 1010. With this type of process, the known profile may be associated with a health state after the known profile is created. Further, the selection of the health state for the known profile may be based on training information and/or maintenance information.

Thus, the different advantageous embodiments provide a method and apparatus for monitoring a platform. In one advantageous embodiment, an apparatus comprises a computer system and a sensor network. The sensor network is associated with a platform. The computer system is connected to the sensor network and is configured to receive information from the sensor network. The computer system is configured to form observations from the information for a current profile. The computer system compares the current profile with a number of known profiles to identify a health state of the platform.

The different advantageous embodiments can take the form of an entirely hardware embodiment, an entirely software embodiment, or an embodiment containing both hardware and software elements. Some embodiments are implemented in software, which includes, but is not limited to, forms such as, for example, firmware, resident software, and microcode.

Furthermore, the different embodiments can take the form of a computer program product accessible from a computer-usable or computer-readable medium providing program code for use by or in connection with a computer or any device or system that executes instructions. For the purposes of this disclosure, a computer-usable or computer-readable medium can generally be any tangible apparatus that can contain, store, communicate, propagate, or transport the program for use by or in connection with the instruction execution system, apparatus, or device.

The computer-usable or computer-readable medium can be, for example, without limitation, an electronic, magnetic, optical, electromagnetic, infrared, or semiconductor system, or a propagation medium. Non-limiting examples of a computer-readable medium include a semiconductor or solid state memory, magnetic tape, a removable computer diskette, a random access memory (RAM), a read-only memory (ROM), a rigid magnetic disk, and an optical disk. Optical disks may include compact disk—read only memory (CD-ROM), compact disk—read/write (CD-R/W), and DVD.

Further, a computer-usable or computer-readable medium may contain or store a computer readable or usable program code such that when the computer readable or usable program code is executed on a computer, the execution of this computer-readable or usable program code causes the computer to transmit another computer-readable or usable program code over a communications link. This communications link may use a medium that is, for example, without limitation, physical or wireless.

A data processing system suitable for storing and/or executing computer-readable or computer-usable program code will include one or more processors coupled directly or indirectly to memory elements through a communications fabric, such as a system bus. The memory elements may include local memory employed during actual execution of the program code, bulk storage, and cache memories, which provide temporary storage of at least some computer-readable or computer-usable program code to reduce the number of times code may be retrieved from bulk storage during execution of the code.

Input/output or I/O devices can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems, remote printers, or storage devices through intervening private or public networks. Non-limiting examples are modems and network adapters and are just a few of the currently available types of communications adapters.

The description of the different advantageous embodiments has been presented for purposes of illustration and description, and it is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
a sensor network associated with a platform in which the sensor network is configured to monitor health of the platform;
a number of systems associated with the platform in which the number of systems and the sensor network are configured to provide information for the platform; and
a computer system connected to the sensor network and the number of systems in which the computer system is configured to receive the information, process the information to form a plurality of observations from the information, and create a current profile from the plurality of observations and the information in which the current profile is used to identify a health state for the platform.

2. The apparatus of claim 1, wherein the computer system is in a location remote to the platform and is connected to the sensor network and the number of systems through another computer system on the platform.

3. The apparatus of claim 1, wherein the computer system is configured to perform a number of operations selected from at least one of receiving at least a portion of the information from the number of systems for the platform; grouping observations in the plurality of observations based on similarities between the observations, in which a number of groups are created to form the current profile; identifying a number of pieces of information in the information; creating an observation from each piece of information in the number of pieces of information to form the plurality of observations; placing the plurality of observations in an associative memory in the computer system to form the current profile for the associative memory; receiving training information obtained during a known health state of the platform to create a known profile in a number of known profiles; using the maintenance information and the current profile to identify a potential cause of the health state for the platform; and selectively generating an alert based on the health state of the platform.

4. The apparatus of claim 1 further comprising:
the number of systems, wherein the number of systems comprises at least one of a navigation system, avionics for an aircraft, an environmental control system, a surface control system, a flight control system, a drive system, a landing system, and a propulsion system.

5. The apparatus of claim 3, wherein the computer system creates the current profile from the plurality of observations by analyzing the associative memory in the computer system.

6. The apparatus of claim 3, wherein the training information comprises information previously collected for the platform, maintenance information about the platform, and timestamps of the information previously collected for the platform.

7. The apparatus of claim 1, wherein in creating the current profile, the computer system is further configured to select a portion of the plurality of observations based on a number of maintenance events performed for the platform to create the current profile.

8. The apparatus of claim 7, wherein the computer system is further configured to associate metadata with the information.

9. The apparatus of claim 8, wherein the computer system is further configured to select the portion of the plurality of observations using the number of maintenance events and the metadata.

10. The apparatus of claim 8, wherein the metadata is comprised of at least one of a timestamp for a piece of information and an identifier of a source of the piece of information.

11. The apparatus of claim 3, wherein the training information for the known health state comprises the information received from one of before a selected date information, after the selected date information, and during a period of time information.

12. The apparatus of claim 1, wherein a portion of the information is received from a maintenance database in the number of systems.

13. The apparatus of claim 1, wherein the information comprises at least one of data, commands, and messages.

14. The apparatus of claim 1 further comprising:
the platform, wherein the platform is selected from one of a mobile platform, a stationary platform, a land-based structure, an aquatic-based structure, a space-based structure, an aircraft, a surface ship, a tank, a personnel carrier, a train, a spacecraft, a space station, a satellite, a submarine, an automobile, a power plant, a bridge, a dam, a wind turbine, a manufacturing system, a building, a wing, a stabilizer, an engine, a hydraulic system, a power transmission gear box, and a shaft.

15. A system for monitoring health of a platform, the system comprising:
a sensor network associated with the platform;
a number of systems associated with the platform, wherein the number of systems and the sensor network are configured to provide information for the platform; and
a computer system associated with the platform in which the computer system is in communication with the sensor network and the number of systems and is configured to receive the information from the sensor network and the number of systems associated with the platform, process the information to form a plurality of observations from the information, group the plurality of observations into a number of groups based on similarities between observations in the plurality of observations to form a current profile, compare the current profile to a number of known profiles to form a comparison, and identify a health state of the platform using the comparison.

16. The system of claim 15, wherein the platform is an aircraft.

17. A method for monitoring a platform, the method comprising:
receiving information from monitoring the platform, wherein the information is received from a sensor network and a number of systems associated with the platform;
forming a plurality of observations from the information; and
creating a profile from the plurality of observations in which the profile is used to monitor the platform.

18. The method of claim 17, wherein the step of forming the plurality of observations from the information comprises:
identifying a number of pieces of information in the information; and
creating an observation from each piece of information in the number of pieces of information to form the plurality of observations.

19. The method of claim 17, wherein the profile is selected from one of a current profile and a known profile and wherein the step of creating the profile comprises:
grouping observations in the plurality of observations to form a number of groups based on similarities between the observations in the plurality of observations.

20. The method of claim 17 further comprising:
associating metadata with the information, wherein the metadata comprises at least one of a timestamp for a piece of information and an identifier of a source of the piece of information.
